(19) United States
(12) Patent Application Publication
(10) Pub. No.: US 2011/0170948 A1
(43) Pub. Date: Jul. 14, 2011

(54) QUICK RELEASE LOCKING MECHANISM FOR SECURING AN INFANT CARRIER TO A BASE

(75) Inventors: Bruce Williams, Narvon, PA (US); Andrew Lehman, Lancaster, PA (US); Scott Anderson, East Earl, PA (US)

(73) Assignee: LERADO (ZHONG SHAN) INDUSTRIAL CO., LTD, Guang Dong Province (CN)

(21) Appl. No.: 13/005,439

(22) Filed: Jan. 12, 2011

(30) Foreign Application Priority Data
Jan. 13, 2010 (CN) CN/201020000767.1

(51) Int. Cl. F16B 17/00

(52) U.S. Cl. 403/321; 403/327

(57) ABSTRACT

A quick release locking mechanism for securing an infant carrier to a base, includes at least a transversal bar, a spring-loaded locking element, a manipulating element and a linking element. The infant carrier is formed with a downward holding slot on the underside thereof, and the base is formed with a upper surface for supporting the infant carrier thereon. The transversal bar is fixed on the base in a position relative to the downward holding slot. The spring-loaded locking element is pivoted on the infant carrier for closing the downward holding slot and retaining the transversal bar within the downward holding slot automatically while the infant carrier is resting on the base. The linking element is connected between the spring-loaded locking element and the manipulating element, and the manipulating element is operatively mounted on the infant carrier for driving the spring-loaded locking element in a remote position.

### CROSS-REFERENCE TO RELATED APPLICATIONS

This non-provisional application claims priority under 35 U.S.C. §119(a) on Patent Application No(s). 201020000767.1 filed in People's Republic of China on Jan. 13, 2010, the entire contents of which are hereby incorporated by reference.

### FIELD OF THE INVENTION

The present invention relates generally to a quick release locking mechanism for securing an infant carrier to a base.

### BACKGROUND OF THE INVENTION

Child safety seats and infant carriers are in wide use. More and more countries require baby and infant to use child safety seats and infant carriers in vehicle. However, to install a child safety seats or infant carriers onto the vehicle seat by original safety belt is always a hard work to the user, accompanying many troublesome problem and waste of time.

Child safety seats and infant carriers may be secured to the vehicle seat by using a locking mechanism onto a base. When lifting the child safety seats and/or the infant carriers from the base, a release handle at the base may be pulled outward to unlock the locking mechanism. However, the release handle is normally equipped at the base and would be hidden below the child safety seats and/or the infant carriers, and not easy to reach.

### SUMMARY OF THE INVENTION

For overcome the problems and achieve quick installation of the child safety seats and/or infant carriers on a vehicle seat, the present invention provides a quick release locking mechanism for securing an infant carrier to a base, includes at least a transversal bar, a spring-loaded locking element, a manipulating element and a linking element. The infant carrier is formed with a downward holding slot on the underside thereof, and the base is formed with a upper surface for supporting the infant carrier thereon. The transversal bar is fixed on the base in a position relative to the downward holding slot. The spring-loaded locking element is pivoted on the infant carrier for closing the downward holding slot and retaining the transversal bar within the downward holding slot automatically while the infant carrier is resting on the base. The linking element is connected between the spring-loaded locking element and the manipulating element, and the manipulating element is operatively mounted on the infant carrier for driving the spring-loaded locking element in a remote position.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective schematic view showing an infant carrier/safety seat with handle being installed on a base in a condition secured by the embodiment of the quick release locking mechanism in accordance with the present invention;

FIG. 2 is an exploded perspective view showing the embodiment of the quick release locking mechanism in accordance with the present invention;

FIG. 3 is an exploded with partial cross-sectional perspective view showing the quick release locking mechanism of the present invention embodied in the base;

FIG. 4 is a cross-sectional elevated view showing the embodiment of the quick release locking mechanism of the present invention secured the infant carrier/safety seat on the base;

FIG. 5 is an enlarged schematic view showing a spring-loaded locking element of the quick release locking mechanism is forcing to move from a close position to an open position automatically, when the infant carrier/safety seat is loading onto the base;

FIG. 6 is a cross-sectional elevated view showing the embodiment of the quick release locking mechanism of the present invention is releasing the infant carrier/safety seat from the base by pulling a handle installed at one end of the infant carrier/safety seat;

FIG. 7 is a cross-sectional elevated schematic view showing a transversal bar of the base is locked in a downward holding slot formed under the infant carrier/safety seat, by the spring-loaded locking element of the quick release locking mechanism of the present invention, when secured the infant carrier/safety seat on the base.

### DETAILED DESCRIPTION OF THE PREFERRED EMBODIMENTS

Reference will now be made in detail to the preferred embodiments of the present invention, examples of which are illustrated in the accompanying drawings.

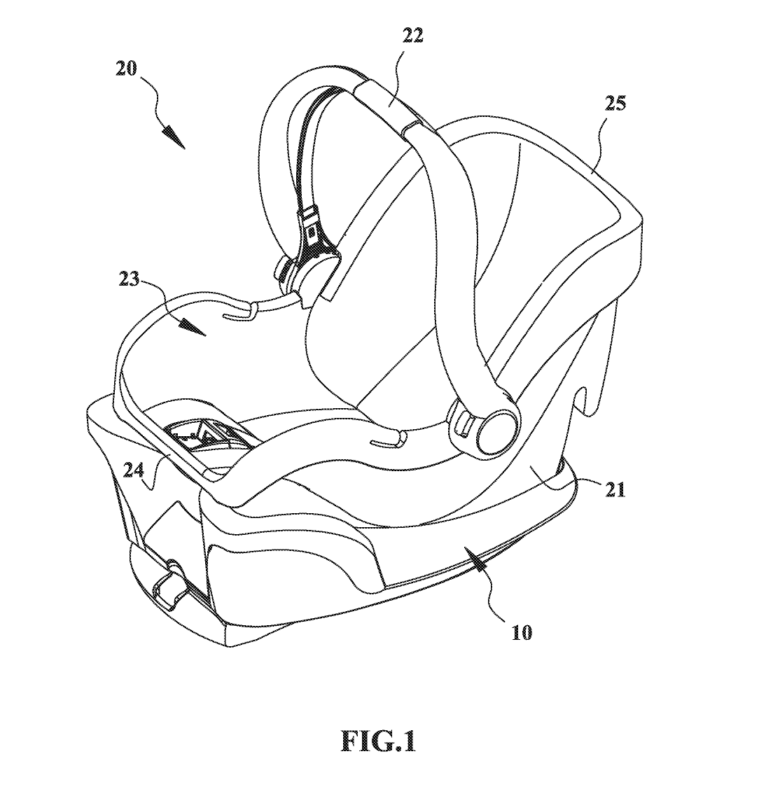

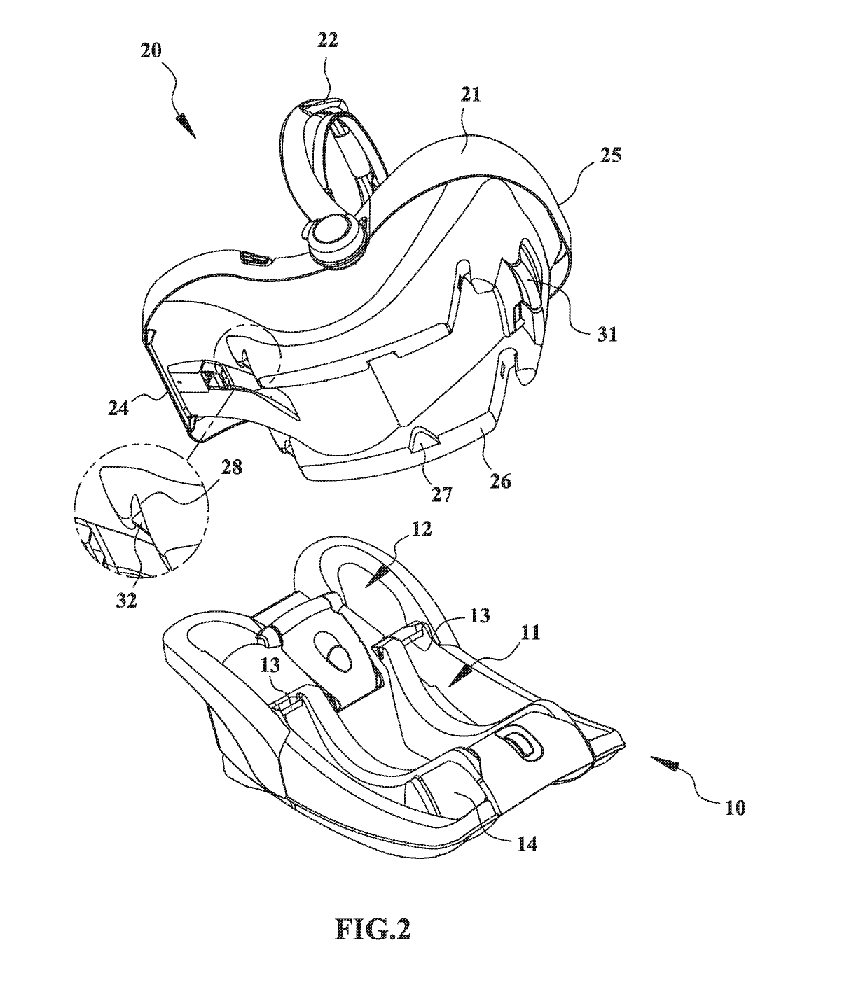

Referring to FIGS. 1 and 2, an infant carrier 20 with a handle 22 is installed onto a base 10 and secured by the embodiment of the quick release locking mechanism 3 in accordance with the present invention.

The infant carrier 20 has a main body 21 formed with an accommodation space 23 for an infant, baby or child sitting or sleeping therein. The main body 21 has a front end 24, a rear end 25 and a underside 26 formed with at least a downward holding slot 28. The underside 26 preferably further includes a guiding indent 27 for guiding the infant carrier 20 to a predetermined position for aiming the downward holding slot 28 at the transversal bar 13 of the quick release locking mechanism 3.

The base 10 is formed with a pair of openings 12 for taking a belt (not shown) to pass through for securing the main body 21 to a vehicle seat (not shown). Preferably, the base 10 may also be formed with a guiding protruded portion 14 on upper surface 11 contoured with the guiding indent 27 in a tapered or triangular configuration, for guiding the base 10 to a predetermined position that help to aim the downward holding slot 28 at the transversal bar 13 of the quick release locking mechanism 3 automatically, when the infant carrier 20 is resting or loading on the base 10.

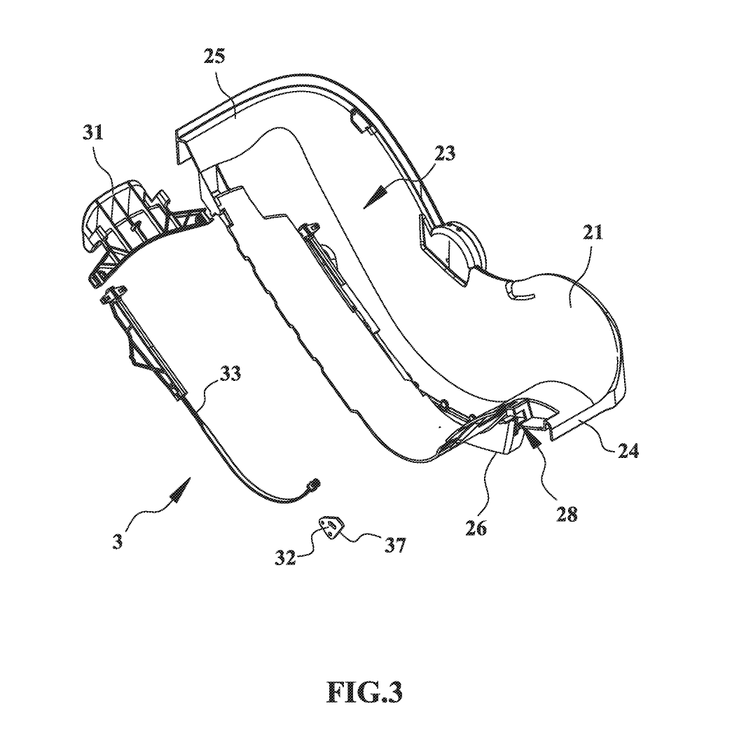

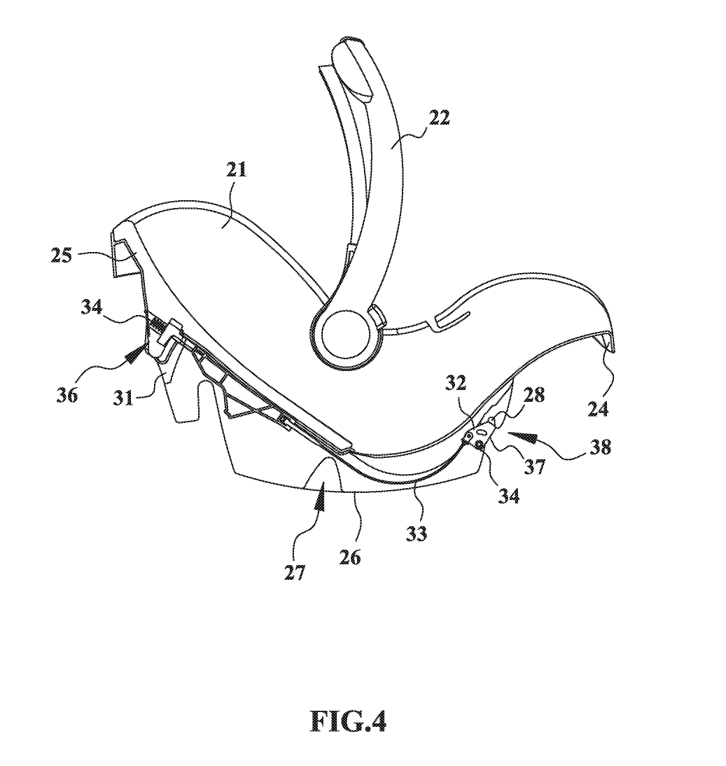

Referring to FIGS. 2 to 5, the embodiment of the quick release locking mechanism 3 according to the present invent invention, includes at least a transversal bar 13, a spring-loaded locking element 32, a manipulating element 31 and a linking element 33.

The infant carrier has a downward holding slot formed on the under side 26 thereof, and the base has a upper surface for supporting the infant carrier 20 thereon. The transversal bar 13 is fixed on the base 10 in a position relative to the downward holding slot 28.

The spring-loaded locking element 32 is pivoted on the infant carrier 20 for closing the downward holding slot 28 and retaining the transversal bar 13 within the downward holding slot 28 automatically while the infant carrier 20 is resting or loading on the base 10.

The linking element 33 may be made of flexible material, such as plastic or wire, with one end connected with the spring-loaded locking element 32, and another end connected with the manipulating element 31. The manipulating element 31 may be embodied as a handle operatively mounted on rear end 25 of the infant carrier 20 for driving the spring-loaded locking element 32 in remote position.

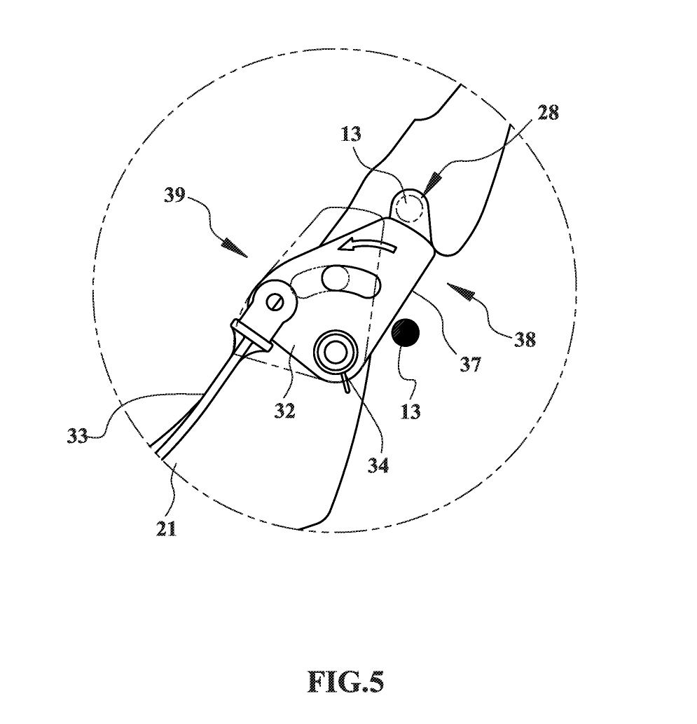

Referring to FIG. 5, the spring-loaded locking element 32 has an abutting edge 37 for contacting with and pushing by the transversal bar 13. When the infant carrier 20 is resting or loading onto the base 10, the spring-loaded locking element 32 shall be pushed by the transversal bar 13 to rotate to an open position 39 that permits the transversal bar 13 to enter the downward holding slot 28.

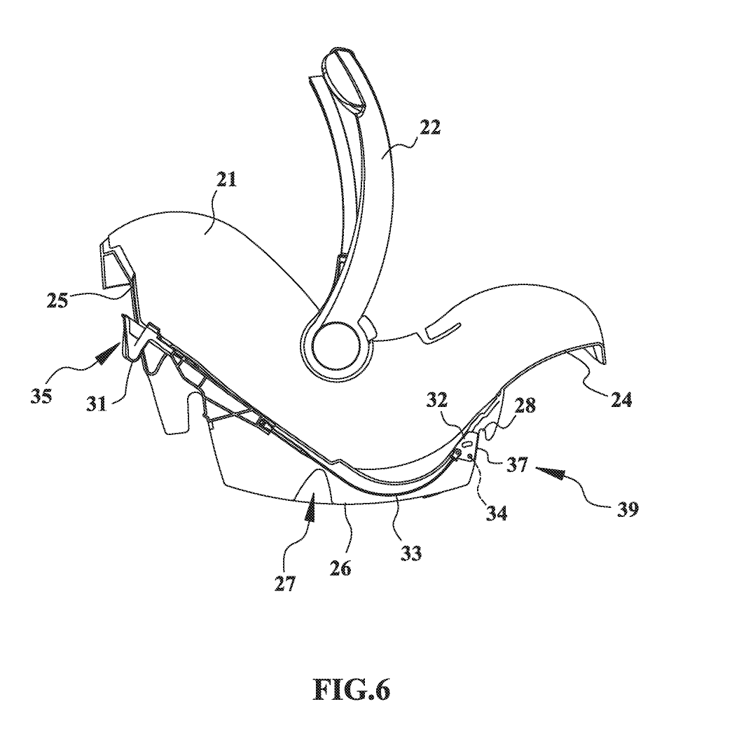

Referring to FIG. 6, when the infant carrier 20 is lifting to depart from the base 10, the manipulating element 31 can be pulled outward from a staying position 36 to an acting position 35 position 39, so as to drive the spring-loaded locking element 32 from a close position 38 to an open position 39 that permits the transversal bar 13 to leave the downward holding slot 28.

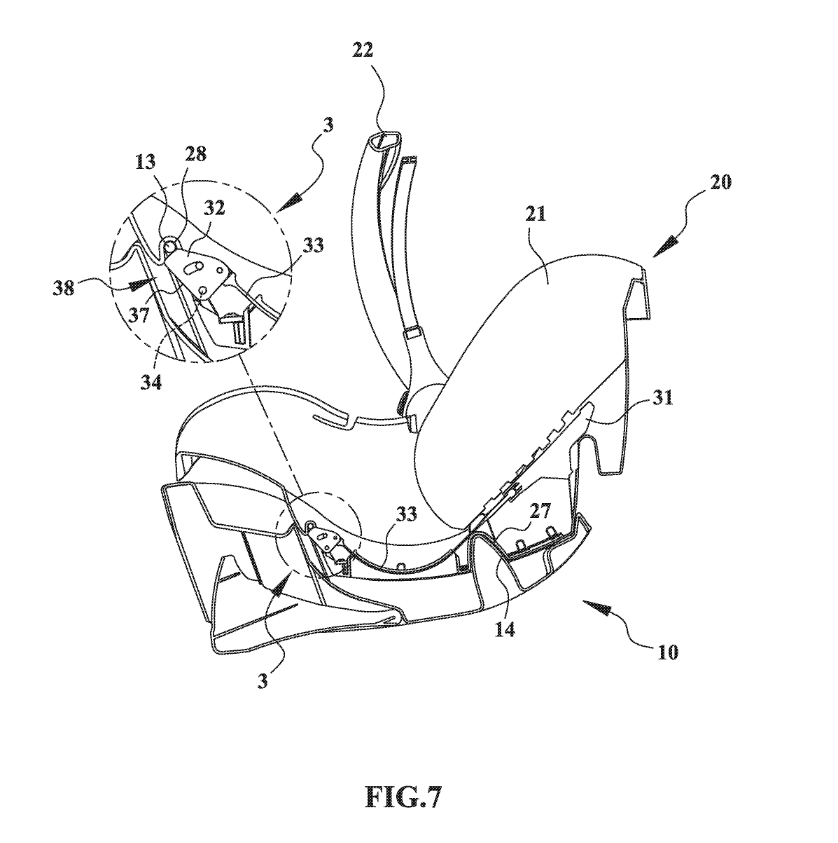

Referring to FIG. 7, the spring-loaded locking element 32 is biased by a resilient element 34 such as a torsion spring and normally kept in the close position 38. When the infant carrier 20 is resting or loading onto the base 10, the manipulating element 31 may be pulled from the staying position 36 to the acting position 35, so as to drive the spring-loaded locking element 32 from the close position 38 to the open position 39 so as to permit the transversal bar 13 to enter the downward holding slot 28 and be retained therein.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A quick release locking mechanism for securing an infant carrier to a base, wherein the infant carrier is formed with a downward holding slot on the underside thereof, the base is formed with a upper surface for supporting the infant carrier thereon, and the quick release locking mechanism including:
at least a transversal bar fixed on the base in a position relative to the downward holding slot;
a spring-loaded locking element pivoted on the infant carrier for closing the downward holding slot and retaining the transversal bar within the downward holding slot automatically, when the infant carrier being rested on the base;
a manipulating element operatively mounted on the infant carrier for driving the spring-loaded locking element in a remote position; and
a linking element connected between the spring-loaded locking element and the manipulating element.

2. The quick release locking mechanism of claim 1, wherein the spring-loaded locking element is pushed by the transversal bar to an open position that permits the transversal bar to enter the downward holding slot, when the infant carrier is resting on the base.

3. The quick release locking mechanism of claim 1, wherein the spring-loaded locking element is driven by the manipulating element to an open position that permits the transversal bar to leave the downward holding slot, when the infant carrier is departing from the base.

4. The quick release locking mechanism of claim 1, wherein the manipulating element can be driven from a staying position to an acting position for driving the spring-loaded locking element to an open position that permits the transversal bar to enter the downward holding slot, when the infant carrier is loading onto the base.

5. The quick release locking mechanism of claim 1, wherein the spring-loaded locking element is biased by a spring toward a closing position for closing the downward holding slot.

6. The quick release locking mechanism of claim 1, wherein the base is formed with a guiding protruded portion for guiding the infant carrier to cause the downward holding slot aimed at the transversal bar automatically, when the infant carrier is resting on the base.

7. The quick release locking mechanism of claim 6, wherein the infant carrier is formed with a guiding indent for contacting with the guiding protruded portion thereby to cause the downward holding slot aimed at the transversal bar automatically, when the infant carrier is resting on the base.

8. The quick release locking mechanism of claim 7, wherein the guiding indent and the guiding protruded portion both are formed in a tapered configuration.

9. The quick release locking mechanism of claim 7, wherein the spring-loaded locking element has an abutting edge for contacting with and pushing by the transversal bar.

10. The quick release locking mechanism of claim 7, wherein the manipulating element is a handle for driving the spring-loaded locking element from a close position to an open position.

11. The quick release locking mechanism of claim 1, wherein the linking element is made of a flexible material and having one end connected with the spring-loaded locking element.
